(19) United States
(12) Patent Application Publication
(10) Pub. No.: US 2008/0035130 A1
(43) Pub. Date: Feb. 14, 2008

(54) Fuel Injector

(76) Inventors: Stefan Arndt, Stuttgart (DE); Martin Maier, Moeglingen (DE); Joerg Heyse, Besigheim (DE)

Correspondence Address: KENYON & KENYON LLP, ONE BROADWAY, NEW YORK, NY, 10004, US

(21) Appl. No.: 10/577,801

(22) PCT Filed: Oct. 21, 2004
(86) PCT No.: PCT/EP04/52604

§ 371 Date: Feb. 20, 2007

(30) Foreign Application Priority Data
Oct. 29, 2003 (DE) 103 50 548.2

(51) Int. Cl. F02M 29/04

(52) U.S. Cl. 123/590

(57) ABSTRACT

Known fuel injectors have a valve-closure member, which cooperates with a sealing seat of a valve seat, and a flow exit region situated downstream from the sealing seat, the fuel spray generated by the fuel injectors having an average droplet diameter that is not small enough for future regulations governing exhaust emission. In the fuel injector according to the present invention the atomization is improved in a simple manner and the average droplet diameter is reduced without additional auxiliary power. The projections which influence the fuel flow are situated in the flow exit region.

### BACKGROUND INFORMATION

U.S. Pat. No. 4,759,335 describes a fuel injector, which has a valve-closure member cooperating with a sealing seat of a valve seat, and a flow outlet region downstream from the sealing seat. The known fuel injector generates a spray whose average droplet diameter is not small enough for future regulations governing exhaust emissions.

### SUMMARY OF THE INVENTION

The fuel injector according to the present invention has the advantage that the atomization is improved in a simple manner in that uneven regions or protrusions, which influence the fuel flow, are situated in the flow outlet region. This allows the average droplet diameter of the spray to be reduced without expending additional auxiliary energy, so that lower exhaust emissions are able to be achieved.

It is especially advantageous if the flow outlet region is formed by a first wall and a second wall which is situated opposite the first wall, an exit gap being formed between the first wall and the second wall, since this makes the fuel jet exit the fuel injector in a defined manner.

It is also advantageous if the second wall having a second flow edge ends downstream from the first wall having a first flow edge when viewed in the direction of the flow, since this constitutes an especially simple specific embodiment.

According to an advantageous exemplary embodiment, the projections have a height—measured perpendicular to a surface of the flow exit region—that is less than 100 micrometers and greater than the roughness peaks of the surface area.

It is very advantageous if the projections are situated in the exit gap because this promotes the generation of a so-called Karmann turbulence path whose periodically detaching vortexes produce turbulence so that the fuel jet disintegrates into smaller droplets than in the related art.

Moreover, it is advantageous if the projections are positioned downstream from the first flow edge since the fuel jet then already disintegrates into many individual jets at the projections, the fuel jets having a large jet surface.

Moreover, it is advantageous if the projections have a cylindrical, tetrahedral, pyramidal, conical, prism-shaped, rectangular, semispherical or nub-shaped form since this allows enough turbulence to be generated in the fuel jet exiting the fuel injector to induce the surface of the fuel jet to oscillate, thereby atomizing the fuel jet into very small droplets.

Furthermore, it is advantageous if the height of the projections increases or decreases downstream in a continuous or stepped manner because the fuel jet is split into many individual jets at the projections, which then collide with other individual jets downstream less often.

According to a second advantageous embodiment, the projections are situated in rows set up transversely to the flow, the rows being arranged at an offset with respect to each other, for instance.

Furthermore, it is advantageous to generate the projections by rasping, micro-embossing, laser removal, etching, micro-electroplating or deposition of a coating since these are suitable methods for creating the projections.

### BRIEF DESCRIPTION OF THE DRAWINGS

FIG. 1 shows a first exemplary embodiment of a fuel injector.

FIG. 2 shows a sectional plan view of the first exemplary embodiment.

FIG. 3 shows a second exemplary embodiment.

FIG. 4 shows a third exemplary embodiment.

FIG. 5 shows a sectional plan view of the third exemplary embodiment.

FIG. 6 shows a fourth exemplary embodiment.

FIG. 7 shows a fifth exemplary embodiment.

FIG. 8 shows a so-called A-valve.

FIG. 9 shows a so-called I-valve.

### DETAILED DESCRIPTION

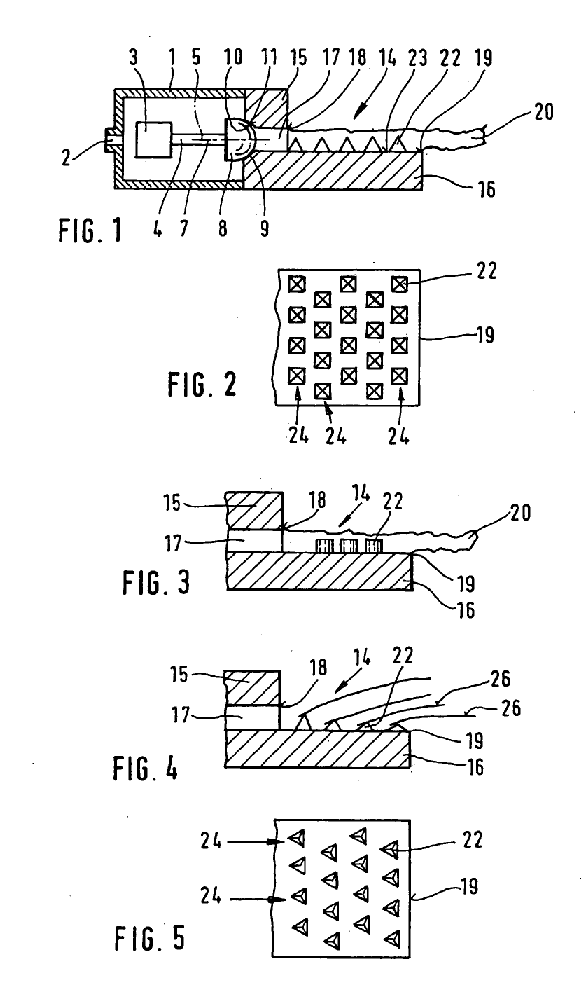

FIG. 1 shows a simplified view of a first exemplary embodiment of a fuel injector configured according to the present invention.

The fuel injector is used to finely atomize fuel in the form of spray in order to lower the fuel consumption and exhaust emissions. In the so-called manifold injection, for instance, the fuel is injected into an intake manifold, or in the so-called direct injection it is injected directly into a combustion chamber of the internal combustion engine.

The fuel injector has a valve housing 1 with an input port 2 for the fuel. Situated in valve housing 1 is a schematically illustrated actuator 3 for the axial adjustment of a valve needle 4. Actuator 3 is, for instance, a magnetic armature which cooperates with an excitable coil, a hydraulic element, a piezoactuator or similar element.

Valve needle 4 is provided in valve housing 1 so as to be axially displaceable and has, for instance, a needle shaft 7 facing actuator 3 and a valve-closure member 8 facing away from actuator 3. Actuator 3 transmits its movement to needle shaft 7 of valve needle 4 directly or indirectly, thereby causing valve-closure member 8, which cooperates with a valve seat 9, to open or close the fuel injector in the direction of a valve axis 5. The fuel injector has, for instance, a so-called ball-cone seat in which valve seat 9 has a conical design, for example, and valve-closure member 8 has a ball or radii section 10 that cooperates with valve seat 9. However, the fuel injector may naturally also have a different design such as a ball-ball seat, a cone-cone seat or a cone-ball seat. When the fuel injector is closed, valve-closure member 8 sealingly rests against valve seat 9, with line and surface contact across its entire circumference, which will be denoted as sealing seat 11 in the following text.

Abutting downstream from valve seat 9 is a flow exit region 14 from which the fuel in the form of a so-called free jet is admixed to the air aspirated by the internal combustion engine.

Flow exit region 14 is formed by a first wall 15 and a second wall 16 situated opposite first wall 15, an exit gap 17 through which fuel 20 discharges when the fuel injector is opened being formed between first wall 15 and second wall 16. First wall 15 extends from sealing seat 11 to a first flow edge 18, and second wall 16 extends from sealing seat 11 to a second flow edge 19 in the flow direction.

First wall 15 and second wall 16 may be joined to one another to make up one part, for instance, or each may also be provided on a separate part. Exit gap 17 is designed as a closed flow channel whose cross section may have various forms, for instance a circular, annular or rectangular form. Second wall 16 having second flow edge 19 ends on the side facing away from sealing seat 11 downstream from first flow edge 18 of first wall 15. However, first flow edge 18 and second flow edge 19 may naturally also be situated in an identical plane perpendicular to valve axis 5.

According to the present invention, uneven regions or projections 22, which project into the fuel stream and thereby influence or interfere with it, are situated in flow exit region 14.

Projections 22 have a raised design compared to, for instance, a surface area 23 of flow exit region 14 formed on second wall 16, and a height, measured perpendicular to surface area 23, that is less than 100 micrometers, for instance, and greater than the height of the roughness peaks of surface area 23.

Projections 22 may be situated adjacent to each other in any desired way, for instance in one or a plurality of rows 24 set up transversely to the flow (FIG. 2). Rows 24 are situated behind each other when viewed in the flow direction; it is possible, for instance, to situate projections 22 of a row 24 at an offset with respect to projections 22 of adjacent rows 24.

Projections 22 may be placed in exit gap 17 and/or, if a second flow edge 19 is situated downstream, downstream from first flow edge 18. Projections 22 may be provided on first wall 15 and/or second wall 16. Projections 22 project from one of the two walls 15, 16 into exit gap 17 and may extend to wall 15, 16 lying opposite.

Uneven regions or projections 22 have, for example, a cylindrical, tetrahedral, pyramidal, conical, prism-shaped, rectangular, semispherical, nub-shaped or similar design.

The orientation of projections 22 relative to the flow is arbitrary; projections 22 may, for instance, be aligned in the direction of the flow via an edge or a surface.

Pyramids or tetrahedrons have a form that is advantageous for the flow in that it avoids or at least reduces flow turbulence on the downstream side, so that no or only very few deposits form on the downstream side of the pyramids or tetrahedrons.

The fuel is guided in valve housing 1 from input port 2 to valve-closure member 8 upstream from sealing seat 11. When the fuel injector is opened, valve-closure member 8 lifts off from sealing seat 11, so that fuel in the form of a fuel jet flows into exit gap 17 of flow exit region 14 via an outlet opening formed between valve-closure member 8 and valve seat 9.

In exit gap 17 the fuel jet is guided across the entire circumference via the area of flow exit region 14, whereas, if second flow edge 19 lies downstream in the flow direction, the fuel jet as partially free jet is only partially guided along the circumference downstream from first flow edge 18. The fuel jet leaves flow exit region 14 of the fuel injector downstream from second flow edge 19 as a completely free jet and disintegrates into many small individual droplets. The smaller the average droplet diameter, the lower the consumption of the internal combustion engine and the lower the exhaust emissions.

The fuel jet discharging through exit gap 17 when the fuel injector is opened flows around and/or across projections 22; considerable turbulence is generated in the stream in the process, which induces oscillations on the surface of the fuel jet. Due to the oscillations on the surface of the fuel jet the fuel jet disintegrates into especially small droplets. This improvement in the atomization is achieved without expending additional energy. The arrangement of projections 22 in flow exit region 14 thus is a simple and cost-effective manner of generating smaller droplet diameters than in the related art.

If projections 22 such as the pyramids and tetrahedrons have beveled surfaces, the fuel jet is split into many individual jets already when flowing around and/or across projections 22 since the flow, which follows the beveled surfaces, is deflected transversely to the main flow and tears off as free jet at the individual downstream edges of projections 22. The individual jets generated at projections 22 have an overall larger jet surface than the fuel jet upstream from projections 22.

Projections 22 are generated also by, for instance, roughening, sand blasting, rolling, micro-embossing, laser removal, etching, micro-electroplating or deposition of a coating.

FIG. 2 shows a plan, simplified partial view of the first exemplary embodiment according to FIG. 1. In the fuel injector according to FIG. 2 the components that remain unchanged or act in the same manner as those in the fuel injector according to FIG. 1 have been characterized by the same reference numerals.

FIG. 3 shows a second exemplary embodiment of a fuel injector in a partial, simplified view.

In the fuel injector according to FIG. 3, the components that remain unchanged or act in the same manner as those in the fuel injector according to FIG. 1 and FIG. 2 have been characterized by the same reference numerals.

The fuel injector according to FIG. 3 differs from the fuel injector according to FIG. 1 in that projections 22 are not formed as pyramids, but as cylinders.

FIG. 4 shows a third exemplary embodiment of a fuel injector in a partial, simplified view.

In the fuel injector according to FIG. 4, the components that remain unchanged or act in the same manner as those in the fuel injector according to FIGS. 1 through 3 are characterized by the same reference numerals.

The fuel injector according to FIG. 4 differs from the fuel injector according to FIG. 1 in that projections 22 are not in the form of pyramids, but in the form of tetrahedrons.

The height of projections 22 such as the tetrahedrons may increase or decrease in the flow direction in a stepwise or continuous manner. Since individual jets 26 tearing off at projections 22 tear off as free jets at different distances from surface area 23, there are few collisions among individual jets 26, so that they are retained and have a large surface.

The height of projections 22 of a row 24 is constant, for instance, but it may also be modified according to a sine curve, for example.

FIG. 5 shows a simplified plan view of a partial view of the third exemplary embodiment according to FIG. 4. In the fuel injector according to FIG. 5, the components that remain unchanged or act in the same manner as those in the fuel injector according to FIG. 1 are characterized by the same reference numerals.

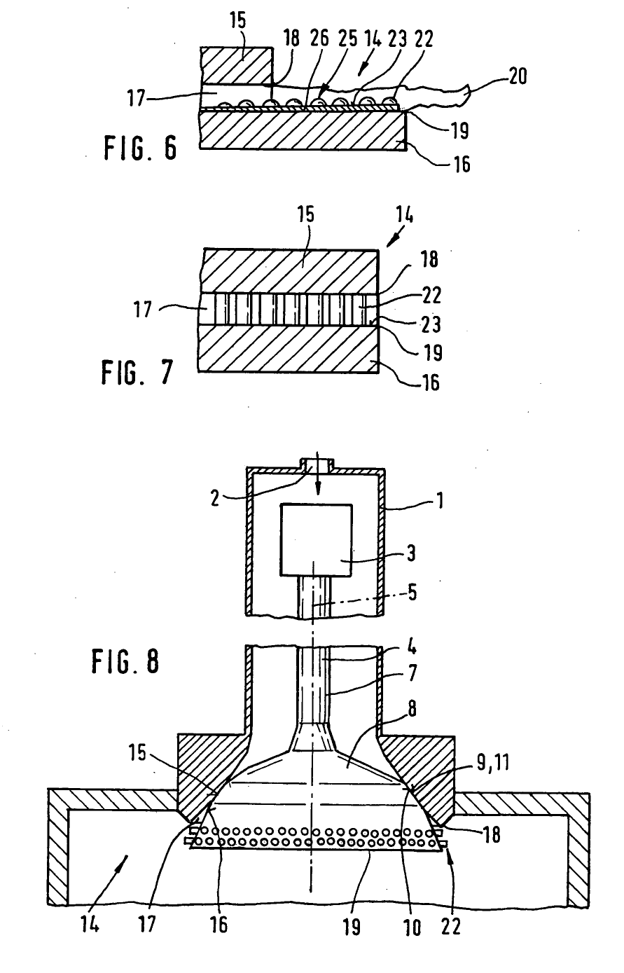

FIG. 6 shows a fourth exemplary embodiment of a fuel injector in a partial, simplified view.

In the fuel injector according to FIG. 6, the components that remain unchanged or act in the same manner as those in the fuel injector according to FIGS. 1 through 5 are characterized by the same reference numerals.

The fuel injector according to FIG. 6 differs from the fuel injector according to FIG. 1 in that projections 22 are in the form of nubs.

Projections 22 are deposited by electroplating, for instance, as a patterned layer 25. Patterned layer 25 is made up of a planar layer 26 on which semispherical projections 22, for instance, are provided. Patterned layer 25 is made of chromium, for example. The diameter of semispherical projections 22 is between 0 and 30 micrometers, for instance. Patterned layer 25 may be produced with the aid of a known chrome patterning method. The thickness of patterned layer 25 continually decreases, for example at an edge of patterned layer 25 facing sealing seat 11, so that a step, which would interfere with the flow of the fuel, is avoided.

The production of patterned layer 25 requires no especially precise working of the surface and thus is simple and cost-effective.

FIG. 7 shows a fifth exemplary embodiment of a fuel injector in a part-sectional, simplified view.

In the fuel injector according to FIG. 7 the components that remain unchanged or act in the same manner as those in the fuel injector according to FIGS. 1 through 6 are characterized by the same reference numerals.

The fuel injector according to FIG. 7 differs from the fuel injector according to FIG. 1 in that projections 22 are situated in exit gap 17 of flow exit region 14 and extend from first wall 15 to second wall 16.

Placing projections 22 in exit gap 17 causes a so-called wake vortex to be formed in the flow downstream from each projection 22, such wake vortex also being known as Karmann turbulence path. With the flow, vortexes periodically detach from each projection 22, which generate additional turbulence in the flow and in this manner promote the disintegration of the fuel jet into the smallest possible droplets. The smaller the cross-section of projection 22 exposed to the flow and the smaller the clearances between projections 22, the higher the turbulence generated by the wake vortex. The mutual offset of individual rows 24 likewise increases the turbulence in the fuel jet.

FIG. 8 shows in simplified form a so-called A-valve whose valve-closure member 8 executes an outwardly directed lift when viewed in the flow direction.

In the fuel injector according to FIG. 8 the components that remain unchanged or the act in the same manner as those in the fuel injector according to FIGS. 1 to 7 are characterized by the same reference numerals.

According to this exemplary embodiment, first wall 15 is formed on valve seat 9, and second wall 16 is formed on valve-closure member 8. Valve-closure member 8 widens in the flow direction from an end of needle shaft 7 facing away from actuator 3 up to second flow edge 19, which is situated downstream from first flow edge 18 formed on valve seat 9 in the flow direction. Valve seat 9 widens downstream from sealing seat 11 up to first flow edge 18.

Exit gap 17 is provided between valve-closure member 8 and valve seat 9.

Projections 22 are provided, for instance, on valve-closure member 8 downstream from sealing seat 11 and upstream from second flow edge 19 and/or on valve seat 9 downstream from sealing seat 11 and upstream from first flow edge 18.

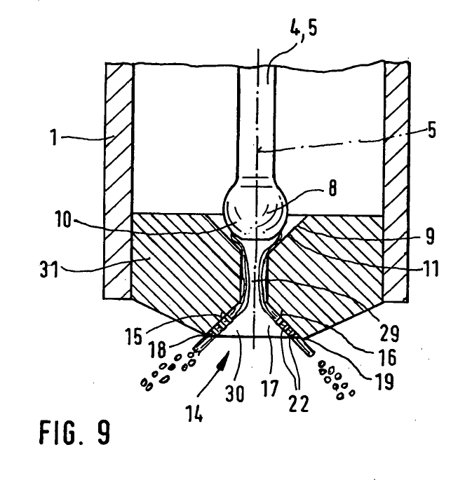

FIG. 9 shows a so-called I-valve in simplified form whose valve-closure member 8 executes an inwardly directed lift, counter to the flow direction.

In the fuel injector according to FIG. 9 the components that remain unchanged or act in the same manner as those in the fuel injector according to FIGS. 1 to 8 are characterized by the same reference numerals.

According to this exemplary embodiment, first wall 15 and second wall 16, which are formed on a valve-seat body 31, form exit gap 17, which is configured as a flow channel. The flow channel has a cylindrical design, for instance, in a first region 29 downstream from the valve seat, and subsequently widens conically in the flow direction in a second region 30. First flow edge 18 and second flow edge 19 lie in one plane. Projections 22 are situated in second region 30, for example.

When the fuel injector is open, the fuel is induced to rotate, for instance with the aid of a swirl disk (not shown), so that the stream entering exit gap 17 forms a rotationally symmetric lamella as a result of the centrifugal force and flows along first wall 15 and second wall 16. The fuel flows around and across projections 22 in the process and is finely atomized downstream from projections 22.

1-12. (canceled)

13. A fuel injector comprising:
a valve seat;
a valve-closure member, which cooperates with a sealing seat of the valve seat;
a flow exit region for fuel situated downstream from the sealing seat; and
projections, which influence fuel flow, situated in the flow exit region.

14. The fuel injector according to claim 13, wherein the flow exit region is formed by a first wall and a second wall lying opposite the first wall, an exit gap being situated between the first wall and the second wall.

15. The fuel injector according to claim 14, wherein the projections are situated on at least one of the first wall and the second wall of the flow exit region.

16. The fuel injector according to claim 14, wherein, relative to the first wall having a first flow edge, the second wall having a second flow edge ends after the first wall having the first flow edge in a flow direction.

17. The fuel injector according to claim 13, wherein the projections have a height, measured perpendicular to a surface of the flow exit region, that is smaller than 100 micrometers and greater than roughness peaks of the surface.

18. The fuel injector according to claim 14, wherein the projections are situated in the exit gap.

19. The fuel injector according to claim 16, wherein the projections are situated downstream from the first flow edge.

20. The fuel injector according to claim 13, wherein the projections have one of a cylindrical, tetrahedral, pyramidal, conical, prism-like, rectangular, semispherical and nub-type shape.

21. The fuel injector according to claim 13, wherein a height of the projections one of (a) increases and (b) decreases downstream in one of (c) a continuous manner and (d) a stepwise manner.

22. The fuel injector according to claim 13, wherein the projections are situated in at least one row set up transversely to the flow.

23. The fuel injector according to claim 22, wherein the projections are situated at a mutual offset from row to row.

24. The fuel injector according to claim 13, wherein the projections are made by one of roughening, micro-embossing, laser removal, etching, micro-electroplating and deposition of a coating.
